(19) United States
(12) Patent Application Publication
(10) Pub. No.: US 2009/0011084 A1
(43) Pub. Date: Jan. 8, 2009

(54) HIGH TRYPTOPHAN SOYBEAN MEAL

(76) Inventors: Jihong Liang, Chesterfield, MO (US); Fang Chi, Libertyville, IL (US)

Correspondence Address: SONNENSCHEIN NATH & ROSENTHAL LLP, P.O. BOX 061080, SOUTH WACKER DRIVE STATION, SEARS TOWER, CHICAGO, IL, 60606, US

(21) Appl. No.: 11/995,066

(22) PCT Filed: Jul. 6, 2006
(86) PCT No.: PCT/US06/26269

§ 371 Date: Sep. 19, 2008

Related U.S. Application Data
(60) Provisional application No. 60/697,452, filed on Jul. 8, 2005.

(51) Int. Cl. A23K 1/14; A23L 1/20

(52) U.S. Cl. 426/53; 426/634; 426/430

(57) ABSTRACT

The present invention is directed to a soybean meal with high tryptophan content and its method of manufacture. The high tryptophan content soybean meal is to be used as an ingredient in animal feeding operations. Also provided are products from the further processing of the soybean meal.

The present invention involves the fields of genetic engineering, plant breeding, grain processing, and animal nutrition. The present invention relates to a novel high tryptophan soybean meal to be used as an ingredient in animal feeding operations.

Animal species raised for meat lack the ability to manufacture a number of amino acids and therefore are required to obtain these amino acids from their diet. The amino acids which must be obtained from the diet are referred to as essential amino acids. Plants are able to synthesize all twenty of the essential amino acids and therefore serve as the primary source of these amino acids for animals. Tryptophan is one of these essential amino acids, and at the same time, is underrepresented in the amino acid profile of many feed ingredients.

Economical sources of protein, such as, by-products from the corn milling and animal rendering plants, are commonly used in animal feeds. Examples of these types of by-products include corn gluten meal, distiller's grains with solubles, meat and bone meal, feather meal, and poultry meal. Unfortunately, the tryptophan content in these by-products is deficient for various animal requirements, and therefore limits the amounts that may be used in certain feed formulations.

Soybean meal is one of the major ingredients of animal feed that provides protein and essential amino acids. When soybean meal is formulated in feed rations, the inclusion rate is typically calculated based on satisfying the most limiting essential amino acid. This limiting essential amino acid is typically tryptophan, resulting in the remaining essential amino acids being formulated in excess of dietary requirements. The excess amino acids end up as waste. The need therefore exists to provide soybean meals with higher concentrations of tryptophan.

### SUMMARY OF THE INVENTION

The present invention described herein relates to a high tryptophan content soybean meal derived from the processing of one or more soybeans having a high total tryptophan content. The present invention includes the use of a high tryptophan content soybean meal in the animal feed industry.

Thus, in a first aspect, the present invention is directed to a soybean meal having a total tryptophan content greater than about 0.78 weight percentage on a dry matter basis (wt. %), wherein no exogenous tryptophan has been added. In one embodiment of the present invention, the soybean meal has at least about 0.10 wt. % free tryptophan. In another embodiment the soybean meal has at least about 0.43 wt. % free tryptophan. In a further embodiment, the soybean meal has a protein content of at least about 44 wt. % or higher. In addition the soybean meal may further have a protein bound tryptophan content comprising transgenically modified protein, wherein the transgenically modified protein contains at least 8 wt. % tryptophan residues.

The present invention relates to a method of making a soybean meal having at least about 0.78 wt. % total tryptophan comprising: introducing into regenerable cells of a soybean plant a transgene comprising an isolated nucleic acid molecule encoding an enzyme in the tryptophan biosynthetic pathway, wherein the isolated nucleic acid molecule is operably linked to a promoter functional in a plant cell, to yield transformed plant cells; and regenerating a plant from said transformed plant cells wherein the cells of the plant express the enzyme encoded by the isolated nucleic acid molecule in an amount effective to increase the tryptophan content in the soybean grain of the plant relative to the tryptophan content in the grain of an untransformed soybean plant of the same genetic background; and producing a soybean meal from the grain of the transformed plant.

In one aspect of the present invention the method includes a transgene which encodes a monomeric anthranilate synthase comprising an anthranilate synthase alpha domain and an anthranilate synthase beta domain. The method further includes a transgene that encodes a feedback insensitive maize anthranilate synthase alpha-subunit. The method further includes any of the transgenes that encode phosphoribosylanthranilate transferase, phosphoribosylanthranilate isomerase, indole-3-phosphate synthase, or tryptophan synthase.

In another aspect, the present invention is directed to a method of producing a high tryptophan content soybean meal comprising: a) selecting soybean grain having a total tryptophan content of greater than about 0.65 wt. %; and b) extracting an oil from said grain to produce a soybean meal. In one embodiment of the present invention, the method of producing a high tryptophan content soybean meal may also use a soybean grain having a free tryptophan of greater than about 0.15 wt. %.

In another aspect, the present invention is directed to incorporating the soybean meal into animal feed, including feed for animal producer, feed for companion animals, and feed for aquaculture. The soybean meal of the present invention is also useful as a fermentation feed source.

In another aspect, the present invention is directed to a high tryptophan content, full fat soybean meal for use in animal feeds. The high tryptophan content, full fat soybean meal may optionally be extruded.

In another aspect, the present invention is directed to a high tryptophan content soybean isolate or soybean protein concentrate.

### DETAILED DESCRIPTION OF THE PREFERRED EMBODIMENTS

The present invention describes a new feed ingredient, a high tryptophan content soybean meal. The meal of the present invention is useful in animal feeding operations, as an aquaculture feed source and as a component of a fermentation media.

The following definitions are used herein:

Exogenous Tryptophan: Tryptophan that is not an intrinsic part of the soybean from which the soybean meal has been produced. Exogenous tryptophan may be added to the meal or to the feed, in order to increase the concentration.

Free Tryptophan: Tryptophan in the free acid form and not part of an oligopeptide, polypeptide, or protein.

Full Fat Soybean Meal: A soybean product, produced similar to soybean meal, except omitting the oil extraction step.

Protein Content: Weight percentage of protein contained in soybean seeds or soybean meal.

Soybean Meal: A feed ingredient that is a product of processing soybean grain. The phrase “soybean meal”, as used herein, refers to a defatted, desolventized, toasted, and ground soybean material.

Soybean Protein Isolate: A preparation from soybean grain made by removing the majority of non-protein components and containing not less than 90% protein on a moisture-free basis.

Soybean Protein Concentrate: A preparation from soybean grain made by removing most of the oil and water soluble non-protein constituents and containing not less than about 65% protein on a moisture-free basis.

Transgene: A nucleic acid molecule, including at least a promoter sequence, a coding region, and a transcription termination sequence, inserted into the genome of a cell via gene splicing techniques.

Total Tryptophan Content: The sum of free tryptophan and protein bound tryptophan contents.

Free Tryptophan Content: The weight percentage of free tryptophan of the soybean grain or soybean meal.

Protein Bound Tryptophan Content: The weight percentage of tryptophan that is incorporated into proteins or peptides in the soybean seed or soybean meal. The phrases “protein bound tryptophan” and “peptide bound tryptophan” are herein used interchangeably.

### High Tryptophan Soybean Varieties

The high tryptophan content soybean meal of the present invention involves the use of a high tryptophan soybean variety or varieties. There are various methods of producing a high tryptophan soybean variety.

Tryptophan in soybean grain exists in two different forms: protein bound and free. Technical approaches for increasing the concentration of free tryptophan in grain include: 1) increasing synthesis, 2) decreasing degradation, or 3) increasing transport from the site of synthesis to the site of storage. Additionally, the combination of any or all of above approaches can be used to achieve optimal results.

Increased synthesis of tryptophan in soybean plants can be achieved by 1) over expressing a key enzyme or enzymes in the biosynthetic pathway, or 2) expressing at least one key enzyme in the biosynthetic pathway that is less sensitive or insensitive to the feedback inhibition as compared to the corresponding endogenous enzyme. Examples of these methods are described in U.S. Patent Publication Nos. 2003/0097677 and 2003/0213010, herein incorporated by reference.

Decreased degradation of tryptophan can be achieved by 1) reducing the amount of the enzyme(s) responsible for degradation, or 2) reducing the effectiveness of the degradation enzymes by expressing an inhibitor of that enzyme, or 3) by expressing a mutant form of the degradation enzyme that would competitively inhibit the activity of the native enzyme. The amount of the enzyme may be reduced by gene suppression techniques such as antisense suppression, sense co-suppression, RNA interference, or other techniques well known in the art.

Plants possess multiple forms of amino acid transporters characterized according to their specificity for, or affinity to, individual amino acids. Over expression of a tryptophan transporter or expression of a more effective tryptophan transporter would facilitate transport of tryptophan from the plastids to other compartments such as cytosolic space, extra cellular space, or vacuoles. See, for example, U.S. Patent Publication No. 2003/0188332.

Protein bound tryptophan can be increased by over expressing a storage protein that contains a high level of tryptophan. The high tryptophan protein can be a native protein or a modified form of a native protein. Examples of these methods are disclosed in PCT Applications WO 98/45458, WO 98/20133, and WO 99/29882.

Additionally, protein bound tryptophan can be increased on a weight percentage basis by increasing the overall concentration of protein in soybean grain, relative to other components such as carbohydrate and lipid. High protein soybeans can be obtained by screening the natural germplasm of soybeans or mutant populations of soybeans.

Another method of increasing protein bound tryptophan is to suppress the expression of native storage proteins that are inherently low in tryptophan. In this method, the amino acid composition of the grain changes in favor of higher levels of tryptophan as compared to a non-suppressed parental line. An example of this method, as specifically applied to corn, but applicable to soybeans, is disclosed in U.S. Pat. No. 6,326,527.

A further method of increasing protein bound tryptophan in soybeans is to engineer the nucleic acid sequences encoding a major storage protein by substituting tryptophan codons in place of those coding for other amino acids. The resulting expressed protein, thus, has higher levels of tryptophan, thereby increasing the total tryptophan level in the plant. An example of this method is disclosed in U.S. Patent Publication No. 2003/0200558.

In yet another method, free tryptophan levels can be increased in a target tissue, and at the same time, a complementary protein sink can be created, which results in an increase in protein bound tryptophan. An example of this method is described in U.S. Pat. No. 6,080,913.

One of ordinary skill in the art will recognize that other methods of producing a soybean grain having high tryptophan content exist, and may be used to generate the high tryptophan content soybean meal of the present invention.

### Soybean Processing and Products

In one aspect of the present invention, high tryptophan soybeans are processed into high tryptophan content soybean meal. Many methods are known for the processing of raw soybeans into soybean meal. The high tryptophan content soybean meal of the present invention may be prepared using these methods to process high tryptophan soybean grain.

Illustrative processes for soybean meal preparation include those taught in U.S. Pat. Nos. 4,992,294; 5,225,230; 5,773,051; and 5,866,192. Typically, commercial soybean processes start with the step of receiving the soybeans from the field by any conventional transport means. The soybeans are typically received in a dirty and often wet condition and may be cleaned with a vibrating screen. In this step the soybeans are separated from non-soybean material, for example, rocks, sticks, leaves, stems, dirt, weed seeds, and unwanted fragments of soybeans. The cleaned soybeans, in combination with the loose hulls that are not removed by the vibrating screen, are transferred to an aspirator in which most of the remaining loose hulls are removed by air. The soybeans are then transferred to storage, and the removed loose hulls are collected as a by-product for further processing.

At this point in the processing, the soybeans typically contain about 12% water, but the actual water content of the soybeans may vary based on a host of different factors. If the water content of the soybeans is in excess of about 12%, then the soybeans may be subjected to a drying step to reduce the water content below about 12% prior to placing in storage. The control of the water content is essential to prevent mold and microbial contamination during storage.

The processing procedures from this point forward may vary depending upon the desired end products. For example, the soybeans may be first dehulled using such conventional equipment as cracking rolls or hammer mills in combination with a conventional aspiration system. Alternatively, the hulls may not be removed prior to further processing. See, for example, U.S. Pat. No. 5,225,230. In order to deactivate antinutritional factors, such as trypsin inhibitors, the soybeans may be subjected to heat for a set period of time prior to cracking, grinding, or crushing.

For cracking processes, clean, dry, whole soybeans are fed to coarsely corrugated roller mills or “crackers.” These crackers can have one or more sets of rolls. Soybean pieces, called “cracks,” are formed. The goal of the cracking step is to maximize the pieces that are ¼^{th} to ⅛^{th} the size of the starting soybean, and to minimize the formation of fines, which are pieces less than 1 mm in diameter.

From the cracking mills, particles of whole soybeans (cracks) are conveyed to multistage aspiration dehulling systems, which typically employ 1 to 3 stages. Each stage consists of an aspirator and a size screening system. At each stage, the fiber-rich hulls are first removed by means of a countercurrent air stream and a cyclone. The heavier, fiber-lean, meats fraction is conveyed to a screening system that removes at least one additional fraction by size, and yields one stream for further aspiration. Alternatively, screening can be employed prior to aspiration. The “hulls” stream is typically combined with other soybean byproducts and used as an animal feed ingredient. The once dehulled meats are then dehulled a second time to bring them to less than about 3% crude fiber (4.28% crude fiber on a defatted, dry basis) using a 2 stage commercial pre-extraction process. However, the single stage systems can also be employed to yield meats.

The resulting meats are then heat conditioned, such as in a rotary or stack cooker. The residence times of the cracks are typically between about 20 and about 40 minutes. Discharge temperatures typically are in the range of about 120 to 180° F. Lower conditioning temperatures may be employed if a greater fines production in the flaker is tolerable.

The conditioned meats are then fed to smooth roller mills called flakers. A force of greater than about 500 kPa-gauge (72.5 psig) is typically applied to the rolls. Flake thicknesses of less than about 0.75 mm (0.030″) are preferably produced in order to obtain maximum oil recovery in the subsequent oil extraction step. Optionally, the cracking and dehulling steps are eliminated, or done subsequent to the conditioning step. An additional option would be to expand a percentage of the flaked soybeans to form “collets” prior to oil extraction. Other process variations include conditioning prior to the cracking step, and eliminating the dehulling step prior to oil extraction. A soybean meal of the present invention produced in a process having the variation of eliminating the dehulling step would be considered a high tryptophan and high fiber soybean meal. This product could be a specialty feed ingredient in a swine production operation.

The next step in the process of generating soybean meal is the extraction of oil. This extraction step is typically done using a lipophilic solvent, but may also be done by mechanical extraction. In this process, the soybean meal is contacted with a suitable solvent (e.g., hexane) to remove the oil to a content of typically less than about 1% by weight. One example of a conventional solvent extraction procedure is described in U.S. Pat. No. 3,721,569.

However, if a “full fat” soybean meal is desired, then the oil bearing meal is not subjected to oil (also known as fat or lipid) extraction. In this embodiment of the present invention, the resulting product would be a high tryptophan content, full fat soybean meal.

At this stage, the solvent extracted, defatted soybean meal typically contains about 30% solvent by weight. Prior to being used as an animal feed, the meal is typically processed through a desolventizer-toaster (DT) to remove the residual solvent and to heat the protein fraction sufficient to inactivate trypsin inhibitors and other naturally occurring toxicants (antifeedants). Typically, steam contacts the soybean meal and the heat of vaporization released from the condensing steam vaporizes the solvent, which is subsequently recovered and recycled.

As an alternative to solvent extraction, the soybean meal is defatted mechanically using, for example, a screw press. This mechanically extracted or “expeller” soybean meal typically contains between about 4 and about 8% residual oil. If the intended use of the meal is as a feed supplement for ruminants, then the meal may first be heated and dried in a specified manner, such as that taught in U.S. Pat. No. 5,225,230, before oil is extracted mechanically. The defatted soybean meal is then dried and typically ground or pelletized, and then milled into a physical state suitable for use as a food supplement or as an animal feed.

Further processing of the soybean or the meal may optionally be done to make the resulting feed more palatable, available, and/or digestible in animals. These processes include addition of enzymes or nutrients, and heat treatment of the meal. Additionally, further processing may be done to the meal, such as pelleting, to make it more compact and dense in distribution.

Further processing of the soybean meal can produce soybean flour, soybean protein concentrates, and soybean protein isolates that have food, feed, and industrial uses. The high tryptophan content soybean meal of the present invention can be further processed into any of the products described below.

Soybean flours are produced simply by grinding and screening the defatted soybean meal. Soybean protein concentrates, having at least about 65 wt. % protein, are made by removing soluble carbohydrate material from defatted soybean meal. Aqueous alcohol extraction (60-80% ethanol in water) or acid leaching at the isoelectric pH 4.5 of the protein are the most common methods of removing the soluble carbohydrate fraction. A myriad of applications have been developed for soybean protein concentrates and texturized concentrates in processed foods, meat, poultry, fish, cereal, and dairy systems, any of which can be employed with the high tryptophan content soybean meal of the present invention.

Soybean protein isolates are preferably produced through standard chemical isolation, drawing the protein out of the defatted soybean flake through solubilization (alkali extraction at pH 7-10) and separation followed by isoelectric precipitation. As a result, isolates are at least about 90 wt. % protein. They are sometimes high in sodium and minerals (ash content), a property that can limit their application. Their major applications have been in dairy substitution, as in infant formulas and milk replacers.

Soybean flours are often used in the manufacturing of meat extenders and analogs, pet foods, baking ingredients, and other food products. Food products made from soybean flour and isolate include baby food, candy products, cereals, food drinks, noodles, yeast, beer, ale, and the like.

One of skill in the art will recognize that variations in the above described procedures may be made without departing from the spirit of the present invention. The high tryptophan content soybean meal of the present invention can be further processed into any of the products described above.

### Feed Formulations

The high tryptophan content soybean meal of the present invention is used in various feed formulations. In a preferred embodiment, the high tryptophan content soybean meal of the present invention is used in feed formulations for simple stomach animals, such as swine and poultry. Due to the higher tryptophan content of the soybean meal of the present invention, inclusion rates are commonly reduced as compared to commodity soybean meal. Use of the soybean meal of the present invention in feed formulations will reduce or eliminate the need to add exogenous sources of tryptophan. These characteristics of the soybean meal of the present invention provide the benefit to the animal producer and formulator of having more options in feed formulation.

The high tryptophan content soybean meal of the present invention allows a formulator to use less expensive ingredients in animal feeds which lowers the feed cost for animal producers. Shown in the table below is a comparison of broiler grower diets using the high tryptophan content soybean meal of the present invention (C), a formulation with no animal by-products (A), and a formulation with animal by-products (B). As can be seen, by being able to use meat and bone meal (MBM) and corn gluten meal with the high tryptophan content soybean meal (HT) of the present invention, the cost per ton of feed is reduced 4-6 dollars.

| | (A) | (B) | (C) |
|---|---|---|---|
| | No animal by- | With animal by- | HT plus animal |
| Ingredients | products | products | by-products |
| Corn | 63 | 64 | 69 |
| SBM | 25 | 24 | — |
| HT | — | — | 18 |
| MBM | — | 4 | 4 |
| Corn gluten meal | 4 | — | 4 |
| Fat | 4 | 4 | 3 |
| Cost, $/2,000 LB | 146 | 144 | 140 |

Listed in the table below are selected feed ingredients and feed formulations, and their crude protein (CP), lysine (Lys), and tryptophan (Trp) contents. It can be seen that certain ingredients containing low tryptophan content yet high protein can be used in formulations with the high tryptophan content soybean meal of the present invention.

| | | Total Amino Acids (%) | | | |
|---|---|---|---|---|---|
| | | | | Trp/Lys | |
| | CP | Lys | Trp | (*100) | Trp/CP (*100) |
| Ingredient Name | | | | | |
| Corn gluten feed | 21.5 | 0.63 | 0.07 | 11 | 0.326 |
| Corn gluten meal | 60.0 | 1.02 | 0.31 | 30 | 0.517 |
| MBM | 51.5 | 2.51 | 0.28 | 11 | 0.544 |
| Feather meal | 84.5 | 2.08 | 0.54 | 26 | 0.639 |
| DDGS¹ | 27.2 | 0.75 | 0.19 | 25 | 0.700 |
| Corn | 8.3 | 0.26 | 0.06 | 23 | 0.723 |
| Poultry byproduct | 64.1 | 3.32 | 0.48 | 14 | 0.749 |
| Distiller grain | 24.8 | 0.74 | 0.2 | 27 | 0.806 |
| Bakery byproduct | 10.8 | 0.27 | 0.1 | 37 | 0.926 |
| Peanut meal | 49.1 | 1.66 | 0.48 | 29 | 0.978 |
| Sunflower meal | 42.2 | 1.2 | 0.44 | 37 | 1.043 |
| Fish meal, | 62.9 | 4.81 | 0.66 | 14 | 1.049 |
| Menhaden | | | | | |
| Rice Bran HF | 13.3 | 0.57 | 0.14 | 25 | 1.053 |
| Milo | 9.2 | 0.22 | 0.1 | 45 | 1.087 |
| Cotton meal | 41.4 | 1.72 | 0.48 | 28 | 1.159 |
| Barley | 10.5 | 0.36 | 0.13 | 36 | 1.238 |
| Midds | 15.9 | 0.57 | 0.2 | 35 | 1.258 |
| Canola meal | 35.6 | 2.08 | 0.45 | 22 | 1.264 |
| Rice | 7.9 | 0.3 | 0.1 | 33 | 1.266 |
| Soybean meal | 47.5 | 3.02 | 0.65 | 22 | 1.368 |
| Blood meal, | 77.1 | 7.04 | 1.08 | 15 | 1.401 |
| conventional | | | | | |
| Wheat | 11.5 | 0.38 | 0.26 | 68 | 2.261 |
| Feed | | | | | |
| Formulations | | | | | |
| Broiler grower | 20 | 1 | 0.18 | 18 | 0.900 |
| Layer | 15 | 0.69 | 0.16 | 23 | 1.067 |
| Turkey Starter B | 26 | 1.5 | 0.24 | 16 | 0.923 |
| Turkey Grower B | 19 | 1 | 0.18 | 18 | 0.947 |
| Turkey Finisher B | 14 | 0.65 | 0.13 | 20 | 0.929 |
| Swine grower 20-50 kg | 18 | 0.95 | 0.17 | 18 | 0.944 |
| Swine finisher 80-120 kg | 13.2 | 0.6 | 0.11 | 18 | 0.833 |

¹DDGS denotes distiller's dried grains with solubles.
Data extracted from NRC poultry (1994) and NRC swine (1998)

The present invention is further detailed in the following Examples, which are offered by way of illustration and are not intended to limit the present invention in any manner.

### EXAMPLE 1

This example describes the generation of transgenic high tryptophan soybeans used to prepare the high tryptophan content soybean meal of the present invention.

The high tryptophan soybeans designated GM_A15238:0015, were generated as described by Weaver et al. (U.S. Patent Publication No. 2003/0213010, already incorporated by reference). Briefly, soybean plants were transformed with the vector pMON39325, containing the coding sequence for a feedback insensitive maize anthranilate synthase (AS) α-subunit driven by a 7S α′ promoter. An event containing a high tryptophan level was selected and numbered GM_A15238. R1 seeds from this event were grown under greenhouse conditions to generate R1 plants. Using the Invader® Assay, (Third Wave Technologies, Inc., Madison, Wis.) identifications of homozygous and heterozygous plants were made. One gene positive homozygous plant (GM_A15238:0015) and one gene negative homozygous plant (GM_A15238:0017) were selected and advanced to further generations. The generation of soybean grain for high tryptophan content soybean meal preparation was executed under the guidance of USDA regulation for regulated transgenic material (see, for example 7 CFR §340).

### EXAMPLE 2

This example sets forth methods of analysis for free and total tryptophan, and total protein in soybean seeds and meal.

### Free Tryptophan

Amino acids in the soybean meal are detected using a pre-column primary amine derivatization with o-phthalaldehyde (OPA). The resulting amino acid adduct, an isoindole, is hydrophobic and possesses excellent fluorescence characteristics, which can then be detected on a fluorescence detector. Using reverse-phase chromatography, separation is achieved through the hydrophobicity of the R-groups located on each amino acid. To help stabilize the fluorophore, a thiol is added such as 2-mercaptoethanol or 3-mercaptopropionic acid.

Seed and meal samples are ground to 1 mm screen fineness or finer. Ground samples are stored at 5° C. prior to analysis. For analysis the samples are brought to room temperature and then weighed directly into conical centrifuge tubes (2.0 ml capacity). The sample to extraction solvent ratio is equal to or less than 30 mg/ml. A 5% trichloroacetic acid (TCA) solution, (part no. VW3372-1, VWR Scientific, West Chester, Pa.) is added to each sample and then mixed by vortex for about 30 minutes. The samples are allowed to sit overnight (16 hours) to ensure extraction completion. The samples are then mixed by vortex for about 30 minutes, centrifuged for 30 minutes at 3000 rpm, and the supernatant is saved and stored at −80° C. prior to analysis.

The amino acids are analyzed by HPLC (model 1100, Agilent Technologies, Inc., Palo Alto, Calif.) with fluorescence detection (FLD) and a Zorbax Eclipse-AAA, XDB C-18 column, Zorbax Eclipse-AAA guard column, and the following parameters:
Analytical time to run method: 14.0 minutes
Total elapsed time per run: Approximately 17 minutes
Typical and minimum sample size: Typical: 50 mg
   Minimum: 30 mg
Typical analytical range: 7.8-800 μmol/μL.

The mobile phases are (A) 40 mM Na₂HPO₄ Buffer at pH=7.8 with 0.001% sodium azide and (B) acetonitrile: MeOH: H₂O (45:45:10 v/v). All reagents are HPLC grade and all solvents are High Purity grade from Honeywell, Burdick and Jackson (Muskegon, Mich.). Below is a chart showing the gradient of the mobile phase used and the HPLC settings.

| Time (min.) | % B |
|---|---|
| 0.00 | 5.0 |
| 1.00 | 5.0 |
| 9.80 | 35.0 |
| 12.00 | 100.0 |
| 12.50 | 5.0 |
| 14.00 | 5.0 |

Temperature: 40° C.

Column Flow: 2.00 mL/min

FLD Settings: Excitation: 340 nm
Emission: 450 nm
Peakwidth: >0.2 min.
PMT Gain: 10

Fluorescence Scan: Excitation Range: 220-380 nm, Step 5 nm
Emission Range: 300-500 nm, Step 5 nm

Crude protein analysis followed AOAC® Official Method 990.03, (2000), (AOAC® International, Gaithersburg, Md.); and amino acid profiles followed AOAC® Official Method 982.30 E (a,b,c), CHP. 45.3.05, (2000).

### EXAMPLE 3

This example sets forth the production of soybean meal at the pilot plant scale.

The soybean meal of the present invention, used in the feeding trials described herein, was prepared at a pilot plant scale, by a solvent extraction process.

The high tryptophan soybeans, GM_A15238:0015 (described in Example 1), as well as the parental line A4922 (Asgrow Seed Company, Des Moines, Iowa), and the negative transgenic isoline, GM_A15238:0017, were cleaned and then dried in a Behlan Wicks drier (Behlen Manufacturing Company, Columbus, Nebr.) to between 10 and 10.5% moisture. The cleaned and dried soybeans were then stored in covered, portable bins for 1-3 days to allow the meats to loosen from the hulls. The beans were then fed into a single strand Ferrell-Ross (A. T. Ferrell Company Inc., Bluffton, Ind.) cracking mill. The cracking rolls operated at ambient temperature at a gap setting of 8, corresponding to 1.9 mm. The rolls operated at a differential speed ratio of 1.5:1 with the slower roll running at 700 ppm.

The cracks produced from the cracking mills were conveyed to a multistage aeromechanical dehulling system (Kice Zigzag Aspirator, Kice Industries, Wichita, Kans.) to remove the hulls from the meats. The aspirator was operated at an absolute pressure of 1-2.4 inches of water. The resulting hulls were collected and fed into a hammer mill. The product from the hammer mill was sent to a gravity table where the meat rich fraction was separated from the hulls and collected. The meats collected this way were blended with the aspirated cracks fraction (blended meats fraction) prior to flaking.

The blended meats fraction was then conveyed at 66-188 kg/hour to a Scott Tenderblend conditioner (model number SJC2, Scott Equipment Company, New Prague, Minn.) and heated to obtain an exit temperature of 55-67° C. and moisture content of 9.5%. The conditioned blended meats fraction was fed into a Roskamp flaking roll model 2862 (28″ diameter X 62″ wide, CPM Roskamp Champion, Waterloo, Iowa) where they were flaked to a thickness of 0.23-0.36 mm, at 60° C., using a gap setting of 0.010 inch.

The flakes were then fed to a Crown Iron Works model 2 percolation extractor (Crown Iron Works Co., Roseville, Minn.) for oil extraction. The extractor was operated using a residence time of approximately 37 minutes, a hexane to meal weight ratio of 1:1, and a throughput of approximately 140 kg/hour. The solvent extracted meal was then conveyed via a Crown Schnecken pre-desolventizer to a two-deck Crown desolventizer toaster (DT). The pre-desolventizer was operated under a pressure of 0.2 inches of water to provide a discharge temperature of 50° C. The DT was operated under the following conditions: the top deck temperature of 91-104° C.; bottom deck temperature of 101-103° C.; and DT vapor temperature of 75±5° C. The resulting meal had an exit moisture level of 16-19% and a urease level corresponding to a pH rise of 0.15±0.5.

The desolventized meal was then dried to a moisture level of 8.5-9.5% and then hammer milled to a particle size small enough to pass through a 12/64 inch screen.

The resulting soybean meals were used in stability tests and in broiler feed trials, described herein below.

### EXAMPLE 4

This example describes and compares protein and tryptophan contents of commercial and high tryptophan content soybean meals, and the corresponding soybean grain used to produce the meals. Shown below in Table 2 are the results from analysis of high tryptophan content soybean meal (HT SBM) of the present invention, commodity soybean meal, commodity soybeans, and a control meal. The control and the high tryptophan soybean meals were processed at the pilot scale as described in Example 3. Also included in Table 2 are values for a soy isolate and a soy concentrate, included for comparison.

TABLE 2
Comparative analysis of soybeans and soybean meals.

| | | | Free | | |
|---|---|---|---|---|---|
| | Moisture | Protein | Trp | Total | Trp/Protein |
| | % | % | (ppm) | Trp % | ratio (×100) |
| Commodity | | 40 | | 0.54 | 1.35 |
| soybean | | | | | |
| Commodity SBM | 12 | 47.7 | | 0.62 | 1.30 |
| Control soybean | 4.77 | 40.1 | 211 | 0.65 | 1.62 |
| Control SBM | 10.57 | | 326 | 0.54 | |
| HT soybean | 4.97 | 40.1 | 3307 | 0.91 | 2.27 |
| HT SBM | 8.61 | | 4341 | 1.20 | |
| Soybean isolate | | 85.8 | | 1.08 | 1.26 |
| Soybean | | 64 | | 0.9 | 1.40 |
| concentrate | | | | | |

Analysis methods used to generate Table 2 are described in Example 2.

### EXAMPLE 5

This example describes the stability determination of free tryptophan in the high tryptophan content soybean meal of the present invention, during processing and storage.

The high tryptophan content soybean meal, described in Examples 3 and 4 above, was used in the stability determinations described herein. Process samples were taken at various stages and analyzed for free tryptophan, as described in Example 2. The analytical results from these samples are summarized below in Table 3. The results demonstrate that there is no significant loss of free tryptophan concentration during the production of high tryptophan content soybean meal. The finished soybean meal retained about 98% of the initial free tryptophan contained in the soybean grain, when normalized to a defatted, dehulled, and moisture free basis. As a comparison, the soybean meal that was subjected to an additional heating time in the DT step of 90 minutes (overcooked soybean meal), had a significantly lower concentration of tryptophan, indicating that degradation was possible under more severe heating conditions.

TABLE 3
Stability and retention of free tryptophan during processing.

| Sample | Free trp* (ppm) | % retention |
|---|---|---|
| HT soybean (whole) | 5032 | 100% |
| Soybean meal after hexane ext. | 4755 | 94% |
| Finished soybean meal | 4927 | 98% |
| Overcooked soybean meal** | 4284 | 85% |

*data normalized to defatted, dehulled, and moisture free basis for comparison purposes
**overcooked meal was generated by increasing the time in the DT by 90 minutes.

Stability testing was conducted to determine the stability of the free and total tryptophan during storage of the meal. Samples of the high tryptophan content soybean meal, described in Examples 3 and 4 above, were stored at 4° C., 22° C., and 38° C., for 6 months in environmental chambers (Enconair Model GC8-2H, Enconair Ecological Chambers Inc., Winnipeg, Mannitoba, Canada). The samples that were stored at 38° C. were also controlled at 60% humidity. A sample of approximately 600 grams high tryptophan content soybean meal was contained in Nalgene jars. Subsamples were analyzed at the time points specified below in Tables 4 and 5, with each time point analysis being run in duplicate.

The results are shown in Tables 4 and 5. The results indicate that both free and protein bound tryptophan are stable in the high tryptophan content soybean meal of the present invention, over 6 months, even at elevated temperatures (38° C.).

TABLE 4
Stability of free tryptophan in high tryptophan
soybean meal during storage.

| | 4° C. | 22° C. | 38° C./60% humidity |
|---|---|---|---|
| Time 0 | | 100.0 | |
| 1 Month | | | 93.8 |
| 2 Months | 104.4 | 105.0 | 99.8 |
| 3 Months | | | 99.2 |
| 4 Months | 96.8 | 97.0 | 94.8 |
| 5 Months | | | 94.2 |
| 6 Months | 98.0 | 96.7 | 95.9 |

TABLE 5
Stability of total tryptophan in high tryptophan
soybean meal during storage.

| | 4° C. | 22° C. | 38° C./60% humidity |
|---|---|---|---|
| Time 0 | | 100.0 | |
| 1 Month | | | 87.9 |
| 2 Months | 92.5 | 91.7 | 90.9 |
| 3 Months | | | 92.0 |
| 4 Months | 89.8 | 90.5 | 91.0 |
| 5 Months | | | 90.7 |
| 6 Months | 91.7 | 91.1 | 89.9 |

In Tables 4 and 5, each data point represents the average of 2 replicates.

### EXAMPLE 6

This example describes a broiler feeding study using a high tryptophan content soybean meal produced as described in Example 3.

A feeding study was performed using a randomized block design comprising 7 dietary treatments and 10 replicates per treatment. The treatments, analysis of the two soybean meals, and the feed formulations used in the study are described in Tables 6 through 8. Seventy Petersime (Zulte, Belgium) cages in 3 batteries were divided into 10 blocks (replicates). The blocks were distributed in such a way that the position and level of the cages within each battery was a blocking factor. A total of 560 male broilers (birds) of the strain Ross 308 (Welp Hatchery, Bancroft, Iowa) were used in this 21 day trial.

When the birds were 7 days of age, they were weighed, randomly assigned to pens, and the test was initiated. The birds had ad libitum access to water and feed throughout the growing period. Mash diets were used across all age periods.

TABLE 6
Description of treatments for feeding trials.

| Treatment | |
|---|---|
| Number | Description |
| 1 | Basal diet, 57% of Trp, 100% of other amino acids |
| 2 | As Treatment 1, plus lower level of parental soybean meal |
| 3 | As Treatment 1, plus higher level of parental soybean meal |
| 4 | As Treatment 2, add free tryptophan to equal level of |
| | Treatment 6 |
| 5 | As Treatment 3, add free tryptophan to equal level in |
| | Treatment 7 |
| 6 | As Treatment 1, lower level of positive isoline soybean meal |
| | (HT) |
| 7 | As Treatment 1, higher level of positive isoline soybean meal |
| | (HT) |

TABLE 7
Measured nutrient concentration of test soybean meal (%)

| | Parental Control | Positive Trp |
|---|---|---|
| Nutrients | (Parent of HT) | isoline (HT) |
| Ash, % | 6.060 | 6.150 |
| Moisture, % | 11.850 | 9.450 |
| Fat, % | 0.850 | 1.200 |
| Protein, % | 49.940 | 50.710 |
| ADF, % | 3.000 | 3.250 |
| NDF, % | 5.500 | 5.750 |
| Threonine | 2.015 | 2.030 |
| Cysteine | 0.840 | 0.855 |
| Valine | 2.410 | 2.425 |
| Methionine | 0.750 | 0.780 |
| Isoleucine | 2.240 | 2.245 |
| Leucine | 3.865 | 3.880 |
| Phenylalanine | 2.505 | 2.505 |
| Histidine | 1.325 | 1.340 |
| Lysine | 3.205 | 3.220 |
| Arginine | 3.615 | 3.600 |
| Tryptophan | 0.75 | 1.225 |

Body weight and feed intake measurements were recorded at approximately day 7, 14, 21, and 28 of the trial to allow for calculation of average daily gain, feed intake, and feed to gain ratio during the 7-14, 14-21, 21-28, and overall periods. Mortality was also recorded throughout the trial.

The room temperature was controlled at 90±2° F. at day 1 and then decreased 1° F. each day until the end of the trial, with daily highs and lows recorded. There was a 23 hour lighting used for the entire experiment with 1 hour dark period from midnight to 1:00 am. Each pen housed 6 birds with a growing density of 0.58 square foot per bird at the start of the trial.

Table 9 shows the factorial analysis of broiler performance data using treatments 2 to 7. For comparison purposes, the average performance of control is also listed. Average trends are very similar among testing periods. Results of 7 to 28 days of age indicate that there were significant differences for feed:gain ratio between the main effects of soybean meal level (P value<0.0001). Because the diets were formulated to have tryptophan as the first limiting nutrient, the positive response of performance due to increasing SBM levels could be attributed to the increased tryptophan content. Performance averages among the main effect of tryptophan source confirms this conclusion. Treatments of parental SBM plus free tryptophan (P+T, Treatments 4 and 5) and positive tryptophan isoline SBM (HT, Treatments 6 and 7) had the same amount of dietary tryptophan, and their performances were very similar (0-28d feed:gain ratios of 1.611 and 1.624 for P+T and HT, respectively). However, birds fed parental SBM diets (Treatments 2 and 3), which contained a lower level of tryptophan, gave a significantly poorer performance (0-28d feed:gain ratio of 1.801). The results of the trial further indicate that the tryptophan in the transgenic high tryptophan meal (HT) is identical to the synthetic tryptophan supplied exogenously (P+T), with respect to bird performance.

TABLE 8
Ingredient and nutrient compositions of
bioavailability trials. Values given are on a weight % basis.

| | | | | Lower level | Higher level | | |
|---|---|---|---|---|---|---|---|
| | | Lower level | Higher level | of parental | of parental | Lower level | Higher level of |
| | Basal, no | of parental | of parental | SBM + free | SBM + free | of positive | positive isoline |
| | SBM | SBM | SBM | trp | trp | isoline SBM | SBM |
| Ingredients and nutrients | TRMT 1 | TRMT 2 | TRMT 3 | TRMT 4 | TRMT 5 | TRMT 6 | TRMT 7 |
| Corn - Fine Ground | 46.689 | 46.689 | 46.689 | 46.689 | 46.689 | 46.689 | 46.689 |
| Corn Gluten Meal 60% Protein | 28.568 | 28.568 | 28.568 | 28.568 | 28.568 | 28.568 | 28.568 |
| Oil - Corn | 3.768 | 3.768 | 3.768 | 3.768 | 3.768 | 3.768 | 3.768 |
| Gelatinized corn starch | 10.000 | 8.254 | 6.514 | 8.240 | 6.486 | 8.207 | 6.421 |
| Solka Floc 200 Fcc | 5.776 | 4.970 | 4.166 | 4.970 | 4.166 | 5.016 | 4.259 |
| Parental SBM | | 2.590 | 5.171 | 2.590 | 5.171 | | |
| L-tryptophan, 98% | | | | 0.0143 | 0.0285 | | |
| Positive isoline SBM (HT) | | | | | | 2.590 | 5.171 |
| CALCIUM CARBONATE | 1.591 | 1.583 | 1.575 | 1.583 | 1.575 | 1.583 | 1.576 |
| Phosphate - Mono Dicalcium | 1.526 | 1.506 | 1.486 | 1.506 | 1.486 | 1.506 | 1.487 |
| Broiler Vitamin Premix | 0.125 | 0.125 | 0.125 | 0.125 | 0.125 | 0.125 | 0.125 |
| Poultry Trace Mineral Premix | 0.050 | 0.050 | 0.050 | 0.050 | 0.050 | 0.050 | 0.050 |
| SALT | 0.428 | 0.431 | 0.434 | 0.431 | 0.434 | 0.431 | 0.434 |
| CHOLINE CHLORIDE-60 | 0.191 | 0.178 | 0.164 | 0.178 | 0.164 | 0.178 | 0.164 |
| L-LYSINE HCL | 0.807 | 0.807 | 0.807 | 0.807 | 0.807 | 0.807 | 0.807 |
| THREONINE | 0.013 | 0.013 | 0.013 | 0.013 | 0.013 | 0.013 | 0.013 |
| L_Arginine, free base | 0.419 | 0.419 | 0.419 | 0.419 | 0.419 | 0.419 | 0.419 |
| Blue lake color | 0.050 | 0.050 | 0.050 | 0.050 | 0.050 | 0.050 | 0.050 |
| Total | 100.000 | 100.000 | 100.000 | 100.000 | 100.000 | 100.000 | 100.000 |

TABLE 9
Main effects and interactions of tryptophan source and
SBM level on broiler performance.

| Treatment | | 7-14 d | 14-21 d | 21-28 d | 0-28 d |
|---|---|---|---|---|---|
| | | — | Feed:Gain | | — |
| Basal | | 2.58 | 2.40 | 2.49 | 2.46 |
| Main Effect | | | | | |
| Trp source | Parental | 1.758a | 1.784a | 1.773a | 1.801a |
| | Parental + trp | 1.526b | 1.603b | 1.610b | 1.611b |
| | Pos. isoline | 1.523b | 1.626b | 1.670b | 1.624b |
| SBM level | Low | 1.750a | 1.818a | 1.792a | 1.809a |
| | High | 1.461b | 1.533b | 1.553b | 1.520b |
| Interactions | | | | | |
| Parental | Low | 1.932 | 1.957 | 1.914 | 1.979 |
| | High | 1.618 | 1.628 | 1.632 | 1.623 |
| Parental + trp | Low | 1.675 | 1.739 | 1.682 | 1.728 |
| | High | 1.392 | 1.481 | 1.528 | 1.481 |
| Pos. isoline | Low | 1.673 | 1.762 | 1.804 | 1.755 |
| | High | 1.373 | 1.490 | 1.501 | 1.461 |
| Statistics | | | | | |
| Trp source | P-value | <.0001 | <.0001 | <.0001 | <.0001 |
| | SEM² | 0.017 | 0.015 | 0.029 | 0.015 |
| | Critical Range³ | 0.053 | 0.046 | 0.092 | 0.048 |
| SBM level | P-value | <.0001 | <.0001 | <.0001 | <.0001 |
| | SEM | 0.014 | 0.012 | 0.023 | 0.012 |
| | Critical Range | 0.041 | 0.036 | 0.072 | 0.037 |
| Source × Level | P-value | 0.8391 | 0.0310 | 0.1377 | 0.0549 |
| | SEM | 0.024 | 0.021 | 0.041 | 0.021 |

### EXAMPLE 7

This example describes the generation of high tryptophan, high protein soybean varieties useful in preparing the high tryptophan content soybean meal of the present invention.

Soybeans, at the R3 generation, that are homozygous for the maize anthranilate synthase α gene (described in U.S. Patent Publication No. 2003/0213010) were crossed to a high protein soybean variety EXP3103REN (described in PCT Application PCT/US05/002503) to produce F1 seed. The resulting F1 seed was planted and grown to maturity to produce F2 seed. The resulting F2 seed was planted and resulting plants were genotyped with respect to glyphosate resistance and tryptophan content. Plants identified as heterozygous for the glyphosate resistance and high tryptophan genes were culled. The resulting F2:3 seed was collected in a single plant harvest and analyzed for free tryptophan (described in Example 2 above), total protein and total oil content using methodologies well known in the art. The results of the F2:3 selections indicate that the high tryptophan phenotype is expressed in a high protein germplasm, at approximately the expected frequency, while maintaining the acceptable oil level (Table 10).

TABLE 10
Effects of high protein levels on tryptophan
content in transgenic soybeans.

| | Number of | Ave Protein | | |
|---|---|---|---|---|
| Event ID | Plants/event | (wt %) | Ave Oil (wt %) | Ave Trp (ppm) |
| 28893 | 5 | 46.5 | 19.8 | 2511 |
| 29353 | 2 | 46.3 | 19.6 | 2622 |
| 29798 | 5 | 46.6 | 19.9 | 2427 |
| 29835 | 2 | 46.2 | 20.1 | 2313 |
| 30039 | 6 | 46.6 | 19.8 | 2866 |
| 30319 | 3 | 46.8 | 19.7 | 2657 |

A single line from each of the events described in Table 10 were advanced to field trials to evaluate seed composition, tolerance to glyphosate herbicide and general agronomics. The field trials utilized a randomized split plot design with duplicates of the following 3 glyphosate treatments; no glyphosate, 1.5 lbs glyphosate acid equivalent (ae)/A at V3 and R1, and 1.5 lbs glyphosate ae/A at V3 and 3.0 lbs glyphosate ae/A at R1 stage. All plots are harvested at maturity and subsamples are analyzed for tryptophan, oil protein, chlorosis, necrosis, plant height, maturity, and yield. The results of the F2:4 trials confirm the earlier result that the high tryptophan trait is expressed in the high protein germplasm. Additionally, the results indicate that that the presence of the high tryptophan trait does not affect the glyphosate tolerance. This example provides an additional soybean source for use in generating the high tryptophan content soybean meal of the present invention. These soybeans are processed into high tryptophan content soybean meal as described above in Example 3.

While the present invention has been disclosed in this patent application by reference to the details of preferred embodiments of the present invention, it is to be understood that the disclosure is intended in an illustrative rather than a limiting sense, as it is contemplated that modifications will readily occur to those skilled in the art, within the spirit of the present invention and the scope of appended claims.

1. A soybean meal, comprising greater than about 0.78 wt. % total tryptophan, wherein no exogenous tryptophan has been added.

2. The soybean meal of claim 1, comprising greater than about 0.8 wt. % total tryptophan.

3. The soybean meal of claim 1, comprising greater than about 0.9 wt. % total tryptophan.

4. The soybean meal of claim 1, comprising greater than about 1.0 wt. % total tryptophan.

5. The soybean meal of claim 1, comprising greater than about 1.3 wt. % total tryptophan.

6. The soybean meal of claim 1, wherein the soybean is not transgenic.

7. The soybean meal of claim 1, wherein the soybean is transgenic.

8. The soybean meal of claim 1, wherein the total tryptophan content further comprises a free tryptophan concentration of at least 0.10 wt. %.

9. The soybean meal of claim 1, wherein the total tryptophan content further comprises a protein bound tryptophan content.

10. The soybean meal of claim 9, wherein the protein bound tryptophan content comprises transgenic protein.

11. The soybean meal of claim 10, wherein the transgenic protein contains at least about 20% tryptophan residues.

12. The soybean meal of claim 1, wherein the soybean has a high tryptophan content as a result of over expressing at least one gene encoding an enzyme in the tryptophan biosynthetic pathway.

13. The soybean meal of claim 12, wherein the enzyme is selected from the group consisting of anthranilate synthase, phosphoribosylanthranilate transferase, phosphoribosylanthranilate isomerase, indole-3-phosphate synthase, and tryptophan synthase.

14. The soybean meal of claim 13, wherein the enzyme is anthranilate synthase.

15. The soybean meal of claim 12, wherein the gene is a transgene.

16. The soybean meal of claim 15, wherein the transgene encodes a feedback insensitive anthranilate synthase.

17. The soybean meal of claim 15, wherein the transgene encodes a monomeric anthranilate synthase.

18. The soybean meal of claim 12, wherein the gene is over expressed as result of a transgenic transcription factor.

19. The soybean meal of claim 1, wherein the soybean expresses a transgene that encodes an enzyme catalyzing a reaction in the tryptophan biosynthetic pathway, and wherein the enzyme is less sensitive or insensitive to feedback inhibition as compared to an endogenous enzyme catalyzing the same reaction.

20. The soybean meal of claim 19, wherein the transgene encodes an anthranilate synthase.

21. The soybean meal of claim 20, wherein the anthranilate synthase is a maize C28 variant.

22. The soybean meal of claim 1, wherein the activities of one or more of the enzymes in the degradation pathway for tryptophan are reduced.

23. The soybean meal of claim 22, wherein the enzymes in the degradation pathway include chorismate mutase, tryptophanase, and tryptophan oxidase.

24. The soybean meal of claim 22, wherein the activities are reduced due to gene suppression of a gene encoding at least one of the enzymes in the degradation pathway for tryptophan.

25. The soybean meal of claim 24, wherein the suppression is accomplished using antisense or sense co-suppression technology.

26. An animal feed comprising the soybean meal of claim 1.

27. A fermentation feed source comprising the meal of claim 1.

28. A soybean protein concentrate produced from the soybean meal of claim 1.

29. An aquaculture feed comprising the soybean meal of claim 1.

30. A method of making a soybean meal having at least about 0.78 wt. % total tryptophan comprising:
a) introducing into regenerable cells of a soybean plant a transgene comprising an isolated nucleic acid molecule encoding an enzyme in the tryptophan biosynthetic pathway, wherein the isolated nucleic acid molecule is operably linked to a promoter functional in a soybean cell, to yield transformed soybean plant cells;
b) regenerating a soybean plant from said transformed soybean plant cells wherein the cells of the plant express the enzyme encoded by the isolated nucleic acid molecule in an amount effective to increase the tryptophan content in a grain of the plant relative to the tryptophan content in a grain of an untransformed soybean plant of the same genetic background; and
c) producing a soybean meal from the grain of the transformed plant.

31. The method of claim 30, wherein the transgene encodes a monomeric anthranilate synthase comprising an anthranilate synthase α-domain and an anthranilate synthase β-domain.

32. The method of claim 30, wherein the transgene encodes a feedback insensitive maize anthranilate synthase α-subunit.

33. A method of producing soybean meal comprising:
a) selecting soybean grain having a total tryptophan content of between about 0.65 wt. % and about 1.2 wt. %; and
b) extracting an oil from said grain to produce a soybean meal.

34. The method of claim 33, wherein said grain has a free tryptophan of greater than 0.15 wt. %.
